(19) United States
(12) Patent Application Publication
(10) Pub. No.: US 2009/0259499 A1
(43) Pub. Date: Oct. 15, 2009

(54) Method and system employing a mobile device for soliciting user experience sharing

(76) Inventors: Sudhir Bhojwani, San Jose, CA (US); Sandeep M. Bhojwani, San Jose, CA (US); David H. Martin, San Jose, CA (US)

Correspondence Address: SCHEIN & CAI LLP;James Cai, 111 W. ST. JOHN ST., SUITE 1250, SAN JOSE, CA, 95113, US

(21) Appl. No.: 12/082,139

(22) Filed: Apr. 9, 2008

(51) Int. Cl. G06Q 99/00

(52) U.S. Cl. 705/7

(57) ABSTRACT

A method and system employing a mobile device for soliciting user experience sharing is disclosed. The method and system electronically solicit a user's experience relating to a product or service purchased from a merchant or service provider. A financial transaction notification message is sent by a financial institution to a user's mobile device following a purchase of the product or service from the merchant or service provider. The financial transaction notification message is related to the financial transaction performed by the user to purchase the product or service and serves to prompt the user to share their experience related to the product or service purchased. The user provides a response using the mobile device that includes an experience annotation reflecting the user's experience. The experience annotation may be provided to the merchant or service provider and/or published to an online service.

### CROSS REFERENCE TO RELATED APPLICATIONS

The present invention is related to commonly assigned patent application entitled “Method and System for Adding Annotations to Financial Transactions” filed on Feb. 5, 2008, the entire disclosure of which is herein incorporated by reference.

### FIELD OF THE INVENTION

The present invention generally relates to methods and systems for experience sharing, and more particularly to a method and system employing a mobile device for soliciting user experience sharing.

### DESCRIPTION OF RELATED ART

Online web-based services such as yelp.com, citysearch.com, and flixster.com enable users to share their experiences related to various activities by supporting user generated online content in the form of reviews, ratings, and commentary. Social networking online web-based services such as facebook.com, myspace.com, and livejournal.com enable users to build online social networks and to share experiences related to their day-to-day activities. Many of these online services provide mobile interfaces for entering user generated content from mobile devices. However, these online services generally do not prompt the user to share their experiences.

Service-oriented merchants, such as hotels, solicit reviews and/or surveys from their customers in order to improve the quality of their services. Product surveys are also well known. These surveys may take the form of paper questionnaires or web-based questionnaires.

Solicitation of reviews has been extended to online purchases by Amazon.com as described in U.S. Pat. No. 6,963,848 entitled “Method and System of Obtaining Consumer Reviews”. After a customer makes an online purchase on Amazon.com, Amazon.com sends the customer an email confirming the purchase and also sends a subsequent email at a predetermined time prompting the user to provide reviews of the items purchased. Receipt of a prompt or reminder makes it more likely that the user will provide a review. The disclosed system relies upon knowledge of the customer's email address to solicit customer reviews.

Email-based communication between a merchant and its customers does not generally exist for merchants and service providers such as hardware stores, grocery stores, retailers, restaurants, chiropractors, spas, hotels, bars, and wineries. As such these merchants and service providers generally do not electronically solicit customer feedback and reviews. Consequently many customers don't have the opportunity to provide feedback, reviews, or share experiences related to these products and services.

There remains a need in the art for a method and system that enables merchants and other service providers to electronically solicit feedback, reviews and other forms of experience sharing.

### SUMMARY OF THE INVENTION

The present invention fills the unmet need in the art and achieves its many objects by providing a computer-implemented method and system for soliciting a user's experience relating to a product or service purchased from a merchant or service provider. A financial transaction notification message is sent by a financial institution to a user's mobile device following a purchase of the product or service from the merchant or service provider. The financial transaction notification message is related to the financial transaction performed by the user to purchase the product or service and serves to prompt the user to share their experience related to the product or service purchased. The user provides a response using the mobile device that includes an experience annotation reflecting the user's experience The experience annotation may be provided to the merchant or service provider and/or published to an online service.

The present invention further provides the user with a means for sharing experiences about activities related to the product or services purchased. The shared experience can include a personal blog and a journal entry which can be published and shared on online sites. Exemplary activities include dining out, recreational activities, and shopping.

Financial transaction notification messages are conventionally sent by financial institutions for such purposes as fraud detection, transaction notification, and transaction authorization. In accordance with the invention, the financial transaction notification message sent by the financial institution to the user's mobile device provides a means to electronically solicit user experience sharing.

The financial transaction notification message may include financial transaction data and a means for prompting and enabling the user to share experiences related to the product or service purchased from the merchant or service provider. Receipt of the financial transaction notification message may serve as the prompt to the user. The financial transaction notification message may also include an explicit invitation to share experiences. The user shares experiences relating to the product or service by responding to the financial transaction notification message. The experience shared by the user in response to the financial transaction notification message is referred to as an experience annotation and may include feedback, a survey, a journal entry, a blog, a review, a rating, and any other sharing of user experience related to the product or service.

The method and system provide a way for merchants and other service providers to obtain user or customer feedback, perform a survey, collect ratings, promote blogging, promote journal entry creation, and solicit reviews. The user shared experience can also be published to online sites.

The financial transaction notification message is sent by a financial institution such as a bank, a third-party working with the bank, or a financial network. The financial transaction notification message is sent to the user after the user performs a financial transaction using a financial instrument provided by the financial institution. The financial instrument may include a credit card, a debit card, a check, an NFC enabled card, a Smart card, and a mobile device (when used for mobile payment). The financial transaction notification message is sent to the user's mobile device. The financial transaction notification message is related to the financial transaction performed by the user with the merchant or service provider to purchase the product or service.

In one aspect of the invention, the financial transaction notification message is sent to the user's mobile device using a messaging protocol including SMS, MMS, Email, WAP Push, USSD, and web services.

The method and system of the invention allow the user to share experiences by responding to the financial transaction notification message using a messaging protocol including SMS, MMS, USSD, Email, WAP Push, and web services. The response may include any combination of text, voice, images, and video. For example, the financial transaction notification message may be delivered to the user as an SMS message and the user may provide feedback by responding to the SMS message with a reply SMS message which includes feedback relating to the service associated with the financial transaction. In another example, the financial transaction notification message may be delivered to the user as an SMS message and the user may provide feedback in an MMS message which contains text and images.

The method and system of the invention allow a user to share experiences by responding to the financial transaction notification message using voice. Voice enables the user to easily share experiences from the mobile device. Voice also provides a richer medium for expressing personal experiences. For example, a voice review of a restaurant can be more compelling than a text review because a person's emotions can be more easily expressed with voice.

In one aspect of the invention, a speech-to-text conversion capability is provided that converts the user's voice recording to text.

In accordance with another aspect of the invention, the user may call a phone number associated with the financial transaction notification message and share experiences related to the product or service in the form of a voice recording. For example, the financial transaction notification message may be delivered to the user as an SMS message including a callback phone number and the user may provide feedback by calling the callback phone number.

The user shared experiences can be stored in a database, provided to the merchant and/or published to online sites.

The method and system of the invention increase the likelihood of the user sharing experiences related to the product or service by soliciting the user experience sharing at a time when the experience is fresh in the user's mind. For example, and in accordance with one aspect of the invention, immediately after the user pays for a meal at a restaurant using a bank issued card, the card issuing bank sends a financial transaction notification message related to the restaurant transaction to the user's mobile device; the financial transaction notification message acts as a prompt for the user to share the user's experience at the restaurant; the user shares the experience at the restaurant in the form of a review; and the review is published to an online site and/or provided to the restaurant.

In accordance with another aspect of the invention, the likelihood of the user sharing experiences related to the product or service may be further increased by including a promotional offer in the financial transaction notification message.

In accordance with another aspect of the invention, the user can share experiences related to the product or service by providing the experience annotation in free form such that the user doesn't need to follow a structured format. In accordance with another aspect of the invention, information is extracted from the experience annotation provided in such free form. For example, heuristics can be applied to extract a numerical rating from the experience annotation, when the experience annotation is in the form of a restaurant review. The effectiveness of the heuristic algorithm to extract information can be improved by limiting it to the context of the financial transaction.

In accordance with yet another aspect of the invention, the details of the financial transaction (also referred to as financial transaction data) may be used to provide the context of the financial transaction, serve the financial transaction notification message, process the response message and publish the experience annotation. Financial transaction data associated with the financial transaction may include transaction location data including an address of the merchant, service provider or card acceptor where the transaction occurred, a merchant name, a merchant identification code, and a merchant zip code. Other financial transaction data associated with the financial transaction includes a transaction type, a merchant type, a transaction amount, and the date and time of the transaction. For example, and in accordance with an aspect of the invention, the user may be invited to give a restaurant review if the merchant type is a restaurant, and not be invited if the merchant type is a grocery store. In another example, and in accordance with another aspect of the invention, for a specific merchant, the user may be prompted to provide feedback in the form of user responses to a customer satisfaction survey, the responses being stored in a database and provided to the specific merchant.

In accordance with another aspect of the invention, the method and system provide for the definition of merchant preferences. Merchant preferences may include whether to solicit user experience sharing, the invitation to be included in the financial transaction notification message, and whether to include a promotional offer encouraging user experience sharing.

In accordance with another aspect of the invention, the user may use a specialized mobile application configured on the user's mobile device that provides a richer user interface for sharing experiences. For example, a mobile application running on the mobile device may intercept the financial transaction notification message served to the mobile device and provide a user interface for enabling user creation of the experience annotation.

In accordance with another aspect of the invention, a computer-implemented method for soliciting a user's experience relating to a product or service purchased from a merchant or service provider includes the steps of: serving a financial transaction notification message to a user's mobile device, the financial transaction notification message being sent by a financial institution, the financial transaction notification message being related to a financial transaction performed by the user to purchase the product or service; receiving a response from the mobile device including an experience annotation, the experience annotation reflecting the user's experience relating to the product or service; and processing the experience annotation.

In accordance with another aspect of the invention, a system for soliciting a user's experience relating to a product or service purchased from a merchant or service provider includes a transaction notification module operable to serve a financial transaction notification message to a user's mobile device, the financial transaction notification message being sent by a financial institution, the financial transaction notification message being related to a financial transaction performed by the user to purchase the product or service, an annotation receiver module operable to receive a response from the mobile device including an experience annotation, the experience annotation reflecting the user's experience relating to the product or service, and an annotation processor module operable to process the experience annotation.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of functional components and method steps to the arrangements of these components and steps set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates a block diagram of the transaction notification and experience annotation process in accordance with the invention;

FIG. 2 illustrates a block diagram of the transaction notification and experience annotation application in accordance with the invention;

FIG. 3 illustrates a block diagram of the transaction notification and experience annotation system incorporated within a banking environment in accordance with the invention;

FIG. 4 illustrates an experience annotation profile in accordance with the invention;

FIG. 5 illustrates an experience annotation record in accordance with the invention;

FIG. 6 illustrates a flow chart of a method of serving a financial transaction notification message;

FIG. 7 illustrates a flow chart of a method of sending an experience annotation in accordance with the invention;

FIG. 8 illustrates a flow chart of a method of receiving and processing the experience annotation in accordance with the invention;

FIG. 9 illustrates a financial transaction notification message in accordance with the invention;

FIG. 10 illustrates an experience annotation response message in accordance with the invention; and

FIG. 11 illustrates an acknowledgment message in accordance with the invention.

### DETAILED DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

A novel computer-implemented method and system for soliciting a user's experience relating to a product or service purchased from a merchant or service provider will now be described. A financial transaction notification message is sent by a financial institution to the user's mobile device relating to the purchase of the product or service from the merchant or service provider. The financial transaction notification message is related to the financial transaction performed by the user to purchase the product or service and serves to prompt the user to share their experience related to the product or service purchased. The user provides a response using the mobile device that includes an experience annotation reflecting the user's experience related to the product or service purchased. The experience annotation may be provided to the merchant or service provider and/or published to an online service.

The financial transaction notification message is sent to the user's mobile device by a financial institution such as a bank, a third-party working with the bank, or a financial network following the purchase of the product or service in which the user uses a financial instrument provided by the financial institution. The financial instrument may include a credit card, a debit card, a check, an NFC enabled card, a Smart card, and a mobile device (when used for mobile payment). The financial transaction notification message is sent to the user's mobile device using a messaging protocol.

Bank issued financial instruments have become popular payment methods for many financial transactions. The method and system described herein advantageously provide a common channel for merchants and service providers to obtain user feedback and other forms of experience sharing. The feedback and other forms of experience sharing may be published to online sites or provided to the merchant or service provider.

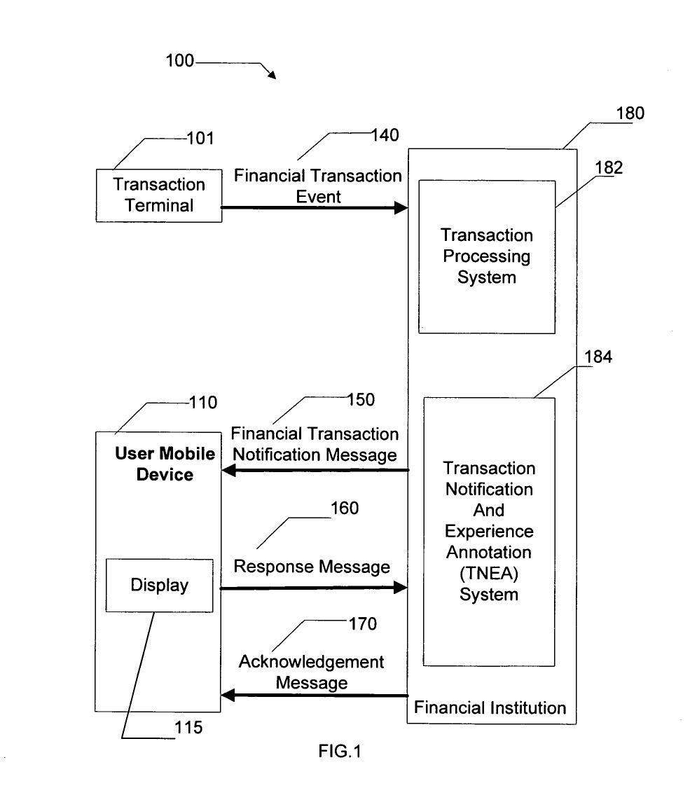

FIG. 1 shows a transaction terminal 101 capable of processing a financial transaction performed by the user, a user mobile device 110 including a display 115, and a financial institution 180 including a transaction processing system 182 capable of processing financial transactions performed on a user's financial account and a Transaction Notification and Experience Annotation (TNEA) system 184. The financial institution 180 can be a card issuing bank, a third-party working with a bank, or a financial network. Transaction processing system 182 and TNEA system 184, shown as part of the financial institution 180, can be hosted by the financial institution 180 or by third-parties.

The transaction terminal 101 may be any device capable of generating a financial transaction event requiring payment from the financial institution. A transaction terminal 101 at a point of transaction origin may include a debit/credit card reader that accepts ATM, debit and credit cards associated with banks and/or credit card companies such as Visa, Master Card, American Express and Discover. The transaction terminal 101 may include a check reader. The transaction terminal 101 may also include a payment system such as a NFC (near-field-communication) based payment system which can support payments made using contactless cards, mobile devices, and other devices. The transaction terminal 101 may also include a virtual terminal such as a pay by phone system and an internet payment gateway in the case of online transactions.

In accordance with an aspect of the invention, a process generally designated 100 comprises the following steps:
The financial institution 180 receives a financial transaction event 140 relating to a financial transaction performed by the user at the transaction terminal 101 to pay for a product or a service. The transaction event 140 is processed by the transaction processing system 182;
The TNEA system 184 serves a financial transaction notification message 150 to the user on the user's mobile device 110 relating to the financial transaction event 140 processed by the transaction processing system 182. The financial transaction notification message 150 may serve as a prompt and may include an explicit invitation encouraging the user to share experiences related to the product or service;
The TNEA system 184 receives a response message 160 from the user's mobile device 110 in response to the financial transaction notification message 150 wherein the response message includes an experience annotation reflecting the user's experience related to the product or service purchased;
The TNEA system 184 processes the response message 160 and the included experience annotation; and
The TNEA system 184 optionally sends an acknowledgement message 170 to the user's mobile device 110.

The process 100 enables the user to share experiences about the product or service related to the financial transaction event 140. The experience annotation may include feedback, a review, a survey, a rating, a blog, and a journal entry. The experience annotation received in the response message 160 can be stored in a database, shared with the merchant or service provider, and published to an online site.

In accordance with another aspect of the invention, the financial transaction notification message 150 served to the user on the user's mobile device 110 provides a context for the user to provide the experience annotation from the mobile device 110 before forgetting the experience or losing the motivation to share the experience related to the product or service. The context included in the financial transaction notification message 150 may include parts of the financial transaction data. Financial transaction data associated with the financial transaction may include transaction location data including a merchant name, an address of a merchant, service provider or card acceptor where the transaction occurred, a merchant identification code, and a merchant zip code. Other financial transaction data associated with the financial transaction include a transaction type, a merchant type, a transaction amount, and the date and time of the transaction.

The process 100 provides a means for the user to share experiences related to the product or service using the mobile device 110 after receiving the financial transaction notification message 150. This increases the likelihood of the user sharing experiences related to the product or service.

The financial transaction event 140 is sent over a communication system that may include the Internet, an intranet, a cellular communication system, a wireless communication system, a wired communication system, a satellite communication system, a cable communication system, and a combination thereof. The financial transaction event 140 may be communicated over one or more banking or financial system networks to the financial institution 180 associated with the user's financial account. The transaction event 140 is stored in a transaction record (not shown) that becomes an electronic transaction receipt for the user.

TNEA system 184 may include at least one processing unit and at least one memory unit implementing and storing a set of instructions for carrying out the TNEA process 100. The TNEA system 184 may also include interfaces for communicating via various communications networks and banking systems.

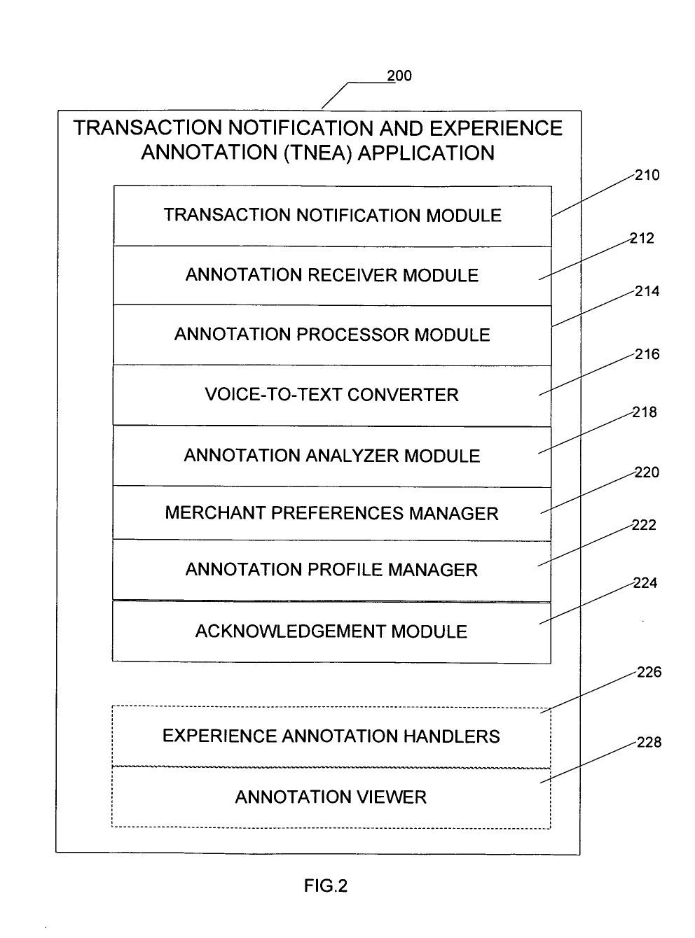

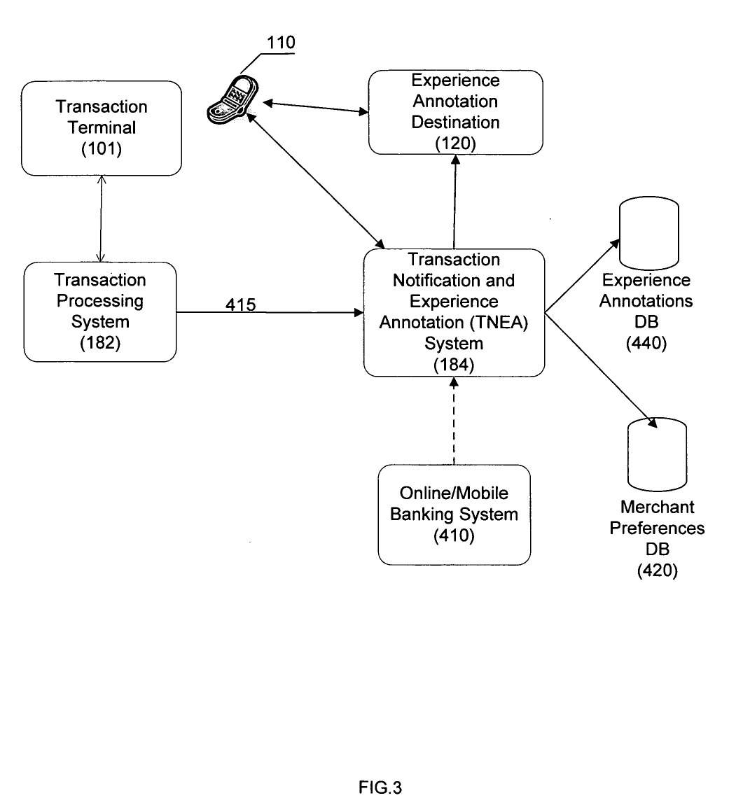

FIG. 2 illustrates a block diagram of a TNEA application 200 implementing the TNEA process 100. The TNEA application 200 includes a transaction notification module 210, an annotation receiver module 212, an annotation processor module 214, a voice-to-text converter 216, an annotation analyzer module 218, a merchant preferences manager 220, an annotation profile manager 222, and an acknowledgement module 224. The TNEA application 200 can optionally provide one or more experience annotation handlers 226 that publish the experience annotations to merchants, service providers, and online sites and an experience annotation viewer 228 used for viewing experience annotations stored in the experience annotations database 440 (FIG. 3).

The transaction notification module 210 is operable to send the financial transaction notification message 150 to the user's mobile device 110. The transaction notification module 210 may send the financial transaction notification message 150 using a messaging protocol including SMS, MMS, WAP Push, email, USSD, XMPP, SOAP, and HTTP. These protocols define how a message is delivered to the user's mobile device 110.

The merchant preferences manager 220 provides at least one interface to manage merchant preferences, and at least one interface to access merchant preferences. Merchant preferences managed by the merchant preference manager 220 are stored in a merchant preferences database 420 (FIG. 3). Merchant preferences include merchant subscription preferences for obtaining user feedback, promotional offers to encourage user feedback and experience annotations, the content of invitations to solicit experience sharing, and acknowledgement messages. Merchant preferences may also define the form of experience sharing preferred by the merchant.

The transaction notification module 210 is further operable to determine whether an invitation soliciting experience sharing is included in the financial transaction notification message 150. The transaction notification module 210 also determines the information conveyed in the financial transaction notification message. The data conveyed in the financial transaction notification message may be based on the financial transaction data, merchant preferences managed by the merchant preferences manager 220, and any combination thereof. For example, the transaction notification module 210 may include an invitation soliciting experience sharing only for certain merchants who have requested such solicitation.

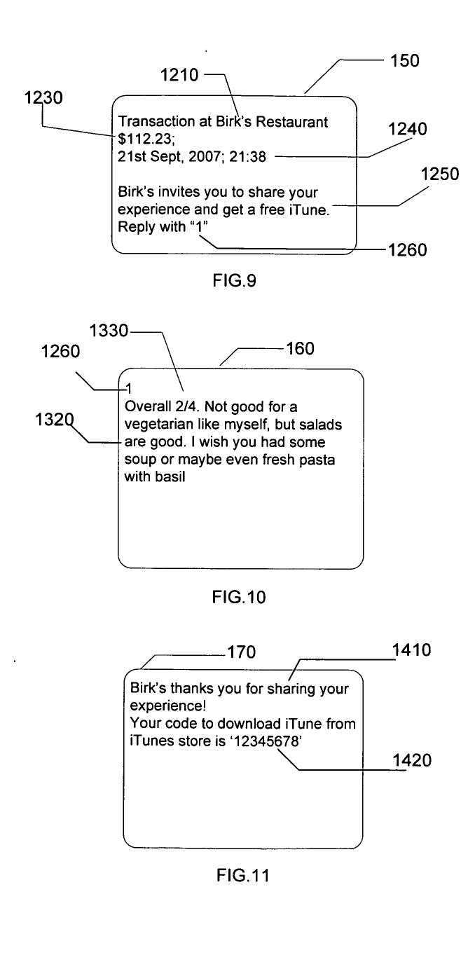

The transaction notification module 210 is further operable to optionally include a promotional offer encouraging user experience sharing in the financial transaction notification message 150. The promotional offer may be a generic promotion encouraging the user to share experiences or a merchant-specific promotional offer specified in the merchant preferences. The promotional offer may be honored after the user shares experiences related to the product or service. The promotional offer can be confirmed in the acknowledgement message. An example of a promotional offer is described hereinafter with reference to FIG. 9.

The transaction notification module 210 may determine the financial transaction details included in the financial transaction notification message 150. The details included in the financial transaction notification message may be complete or partial depending upon system preferences and the protocol used for sending the financial transaction notification message 150. For example, some protocols such as SMS or USSD restrict the number of characters that can be sent in one message. In such situations, the details included in the financial transaction notification message may employ shorthand. Furthermore, the details included in the financial transaction notification message may be complete or partial depending upon the nature of the financial transaction and information necessary to provide context and to prompt the user to share experiences.

The annotation receiver module 212 is operable to receive experience annotations provided by the user in the response message 160. The response message 160 can include any combination of voice, text, images, and video. The response message 160 can be received by the annotation receiver 212 using messaging protocols including SMS, MMS, WAP Push, email, USSD, XMPP, SOAP, and HTTP. The response message 160 can also be received by the annotation receiver module 212 as a voice recording.

The TNEA application 200 supports heterogeneous 2-way messaging. Heterogeneous 2-way messaging involves serving a message to the user's mobile device 110 using one messaging protocol and receiving the response message 160 using a different messaging protocol. The transaction notification module 210 may use one messaging protocol for serving the financial transaction notification message 150 to the user's mobile device 110, and the annotation receiver module 212 may receive the response message 160 using a different messaging protocol. For example, the transaction notification module 210 may send the financial transaction notification message 150 to the user's mobile device 110 as a SMS message and the response message 160 may be received by the annotation receiver module 212 as a MMS message. The annotation receiver module 212 is capable of correlating the response message 160 to the financial transaction notification message 150. This allows the annotation receiver module 212 and other modules such as the annotation processor module 214 to associate experience annotations to the merchant or service provider associated with the financial transaction.

Heterogeneous 2-way messaging provides flexibility to the user when responding to the financial transaction notification message 150. For example, the user may prefer to provide experience annotations in the form of voice recordings from the user's mobile device 110 in response to the financial transaction notification message 150 received as a SMS message. In this case, sending a voice recording in the response message 160 may involve sending the reply message as an Email or a MMS message because SMS messages can only contain text. Heterogeneous 2-way messaging further enables integration of the TNEA system 184 with carriers supporting a variety of messaging protocols.

The response message 160 can also be received by the annotation receiver module 212 through an Interactive Voice Response (IVR) system that provides an interactive voice-based method for the user to provide experience annotations. The user provides experience annotations by calling a callback phone number included in the financial transaction notification message 150. The callback phone number provided may also be used by the IVR system to identify the financial transaction (product and service) for which the user is providing the experience annotation. The TNEA application 200 may send a callback phone number in the financial transaction notification message 150, wherein the phone number corresponds to the financial transaction performed by the user.

The response message 160 can also be received by the annotation receiver module 212 through a voice recording system that allows the user to record experience annotations as voice recordings. The user may call a callback phone number provided to the user in the financial transaction notification message 150.

The voice-to-text converter 216 is operable to convert received voice recordings to text. The voice-to-text converter 216 selects a grammar to be used for this conversion depending upon factors including an experience annotation type (review, feedback, blog, etc.), a product type, a service type, a merchant category, and a financial transaction type.

The annotation processor module 214 is operable to process the experience annotations received by the annotation receiver module 212. As a part of processing, the annotation processor module 214 may interface with other TNEA application modules including the voice-to-text converter 216, the annotation analyzer module 218, the acknowledgement module 224, and the experience annotation handlers 226. The annotation processor module 214 may store the experience annotations in an experience annotations database 440 (FIG. 3). The annotation processor module 214 may produce an experience annotation record 500.

The annotation analyzer module 218 is operable to extract information from the experience annotation. The annotation analyzer module 218 may extract the information from the experience annotation for various purposes such as determining a customer satisfaction level or a rating. The annotation analyzer module 218 may extract information from the experience annotation based on information including the experience annotation type, the product, the service type, and other financial transaction data. For example, the annotation analyzer module 218 may extract rating information from a restaurant review annotation; the extracted information may include a rating for food quality, a rating for ambience, and a rating for service.

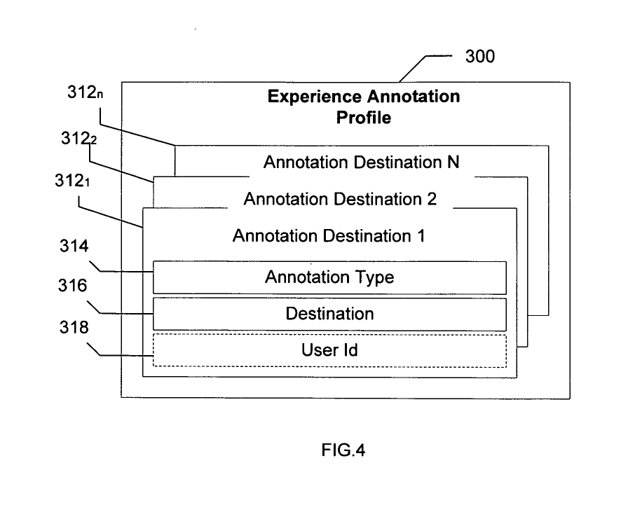

The TNEA application 200 may optionally include an annotation profile manager 222. The annotation profile manager 222 is operable to manage an experience annotation profile 300 as described with reference to FIG. 4. The annotation profile 300 may be used for publishing the experience annotations to experience annotation destinations such as online sites.

The TNEA application 200 may optionally include an acknowledgement module 224 operable to send the acknowledgement message 170 to the user's mobile device 110. The acknowledgement message 170 is also operable to determine the content of the acknowledgement message 170 based on factors including the customer satisfaction level determined by the annotation analyzer module 218, merchant preferences, and promotional offers.

The experience annotation handlers 226 are operable to handle experience annotations including tracking and publishing the experience annotations to specific experience annotation destinations. For example, the experience annotation handlers 226 may include a review publishing handler (not shown) that is operable to publish an experience annotation to an online review site. Similarly the experience annotation handlers 226 may include a journal entry publishing handler (not shown) operable to add experience annotations to a user's journal maintained with a journal site such as Livejournal.com.

The TNEA application 200 may also include an experience annotation viewer 228 operable to provide access to the experience annotations stored in the experience annotations database 440.

TNEA application modules described herein can be hosted by the financial institution 180, by a third-party, or jointly wherein certain modules are hosted by the financial institution 180 and other modules are hosted by other third-parties. The annotation receiver module 212, annotation processor module 214, and other TNEA application modules may be hosted by an experience annotation destination (for example an online site) in which case experience annotations provided by the user from the mobile device 110 as described in the process 100 will be received by the annotation receiver module 212 hosted by the experience annotation destination. The financial transaction notification message 150 in this case may provide a more detailed description of the financial transaction in the financial transaction notification message 150 which can be used by a mobile application running on the mobile device 110 when sending the response message 160 to the annotation receiver module 212 co-hosted with experience annotation destination systems. Alternatively, the financial transaction notification message 150 may provide an invitation inviting the user to share experiences by calling a phone number specific to the merchant or service provider in which case a more detailed description of the financial transaction may not be needed.

FIG. 3 illustrates a block diagram of the TNEA system 184 in a banking environment in accordance with one aspect of the invention. The TNEA system 184 integrates with other banking systems including the transaction processing system 182, and online/mobile banking systems 410. The TNEA system 184 and various banking systems may be hosted by various parties. In accordance with one aspect of the invention, the TNEA system 184 includes the modules of the TNEA application 200 and other banking system modules hosted by a financial institution such as a bank. In another aspect of the invention, the TNEA system 184 includes modules of the TNEA application 200 and may be hosted by one or more third-party service providers wherein the banking system modules may be hosted by the bank or other third-parties.

The transaction processing system (TPS) 182 is responsible for processing financial transactions on a user's financial account upon receiving the financial transaction event 140 (FIG. 1). The TPS 182 may receive financial transaction events from a financial network or other payment processing systems. Those skilled in the art will recognize that the TPS 182 can be hosted by a financial network. The TPS 182 may receive financial transaction events through other systems including check processing systems.

The TPS 182 integrates with the TNEA system 184 using an application programming interface (API) 415 provided by the TNEA application 200 running on the TNEA system 184. The TNEA application 200 modules previously described may be physically deployed on multiple physical servers. In one aspect of the invention, the transaction notification module 210 and other modules including the annotation receiver module 212 may be deployed together. In another aspect of the invention, the transaction notification module 210 and other modules including the annotation receiver module 212 may be deployed separately. In yet another aspect of the invention, the financial institution may have an equivalent of the transaction notification module 210 serving the financial transaction notification messages 150. In such a case, the existing transaction notification module 210 may be utilized or enhanced to support the TNEA application 200. For example the existing transaction notification module 210 may be capable of sending the financial transaction notification message 150 as an SMS message but is enhanced to include a prompt soliciting experience sharing in the form of an action code in the SMS message, adding a callback phone number to the SMS message, or adding a URL to the SMS message. However, it is also possible to support the TNEA application 200 without enhancing the bank's existing transaction notification module itself. For example, a specialized mobile application running on the mobile device 110 may be provided where the mobile application receives the financial transaction notification message 150 and enables the user to provide experience annotations.

The TNEA system 184 is operable to send financial transaction notification messages 150 to the user's mobile device 110. The TNEA system 184 integrates with a wireless carrier network using various Application Programming Interfaces (API) provided by the wireless carrier network. These APIs may be different for different wireless operators. In an alternative configuration, the TNEA system 184 may interface with an SMS Aggregator that integrates with the wireless operator. This may be done for various business or technical reasons which require the financial transaction notification messages to be delivered through an SMS aggregator.

The TNEA system 184 is operable to send financial transaction notification messages 150 using messaging protocols supported by the wireless carrier network and the user's mobile device 110. Supported messaging protocols include SMS, MMS, WAP Push, Email, Mobile Email, USSD, SOAP, HTTP, and XMPP. It is also capable of supporting a trigger based mechanism of delivering the financial transaction notification message 150. In the trigger based method, the TNEA system 184 first sends a trigger message to the user's mobile device 110. The trigger message acts as a trigger to a mobile application running on the mobile device 110 to fetch the financial transaction notification message 150.

The TNEA system 184 may also integrate with other systems, instead of directly connecting with the wireless carrier, for delivering financial transaction notification messages 150. For example, sending an email to the user's mobile device 110 may not require a direct integration between the TNEA system 184 and a wireless carrier. The TNEA system 184 may integrate with an email server which delivers an email to the user's mobile device 110 using technology such as Blackberry.

Mobile device 110 receives the financial transaction notification message 150 relating to the financial transaction performed by the user. The user can provide experience annotations related to the product or service associated with the financial transaction by responding to the financial transaction notification message 150 from the user's mobile device 110 using voice, text, images, and video. The response message 160 is received by the TNEA system 184 through a wireless carrier network. As an example, the user may have received a financial transaction notification message 150 as an SMS message but responds with voice which is sent as a MMS message. This MMS message is delivered as an email or an MMS message to the TNEA system 184. The TNEA system 184 supports the TNEA application 200 as described with reference to process 100 (FIG. 1). The TNEA system 184 may also receive the experience annotations included in response messages 160 through a voice recording system or an IVR system as previously described.

The TNEA system 184 includes the merchant preferences database 420 used for storing merchant preferences. Merchant preference manager 220 provides at least one interface to maintain merchant preferences stored in the merchant preferences database 420. The interface may be in the form of a web interface or an application programming interface.

The TNEA system 184 includes an experience annotation database 440 used for storing experience annotations. The TNEA system 184 may optionally publish the experience annotations to one or more experience annotation destinations 120. The experience annotation viewer 228 may allow merchants access to experience annotations stored in the experience annotation database 440. The access can be based on security and authorization rules that restrict access to the experience annotations.

Online/Mobile banking systems 410 provide a graphical user interface (GUI) to the user for use in various banking services. These systems may support management of the experience annotation profile 300.

FIG. 4 illustrates a block diagram of the experience annotation profile 300. The experience annotation profile 300 is used by the experience annotation handlers 226 to publish the experience annotations to experience annotation destinations 120. Alternatively, the TNEA application 200 may not need to maintain the experience annotation profile 300 in case the experience annotations are only stored in the experience annotation database 440 and not published to online sites.

The experience annotation profile 300 includes 1 to n annotation destination specifiers 312₁, 312₂, . . . 312ₙ used for publishing experience annotations to a specific experience annotation destination 120. Annotation destination specifiers 312₁, 312₂, . . . 312ₙ include an annotation type 314, a destination 316, and, optionally, a user id 318. The annotation type 314 together with the destination 316 is used in selecting the experience annotation destination 120 for publication of the experience annotation. The value for the destination 316 can simply be a destination name or an identifier that uniquely defines the destination for publishing the experience annotation. The user id 318 defines the user id in the experience annotation destination 120. This field is optional because the TNEA system 184 can also use a user's mobile number as an identifier for the experience annotation destination 120 or in some cases experience annotations can be published by an anonymous user. The experience annotation profile 300 is shown as an illustration to show the publishing aspect of the TNEA application 200. However, in a different configuration, the experience annotation profile 300 can be stored on a user's mobile device 110 (FIG. 1) in which case the experience annotation may be published directly to the experience annotation destination 120 from the mobile device 110.

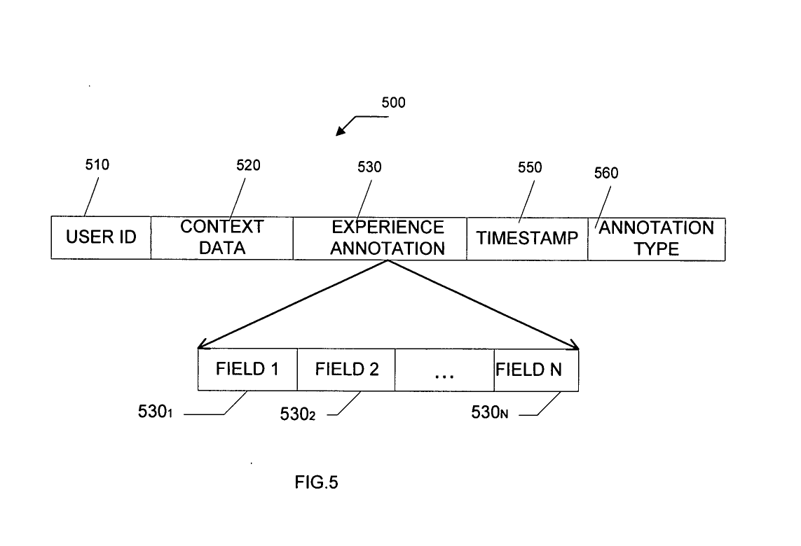

FIG. 5 shows an experience annotation record 500 used for tracking and publishing a user provided experience annotation. The experience annotation record 500 includes a user id 510, an experience context data 520, an experience annotation 530, a timestamp 550, and an annotation type 560. The user Id 510 identifies the user creating the experience annotation 530.

The experience context data 520 contains data required to track and publish the experience annotation 530. The experience context data 520 is derived from the financial transaction data and generally includes the name and place where the product or services was purchased and the date and time of the purchase. As an example, when annotating a dinning experience at a restaurant in the form of a review, the experience context data 520 includes the restaurant name and location together with the date and time of the dinning experience.

The experience annotation 530 contains the user provided experience annotation which may include text, voice, images, and video. TNEA application 200 may apply heuristics to user provided experience annotations before publishing the experience annotations to the experience annotation destination systems 120. The experience annotation 530 may be broken into multiple fields 530₁, 530₂, . . . 530_{N}. As an example, the user may review a restaurant using voice and include a restaurant rating; the annotation analyzer module 218 can extract the rating data from the experience annotation and stores it in one of fields 530₁, 530₂, . . . 530_{N}.

Timestamp 550 defines the date and time when the user created the experience annotation 530. The annotation type 560 specifies the type of the experience annotation. The annotation type 560 can be determined based on the merchant type. The annotation type 560 can also be explicitly specified by the user using a keyword specified in the response message 160.

FIGS. 6-8 are flowcharts illustrating the TNEA process 100. In various configurations below, flowchart steps are performed in the depicted order or the steps or portions thereof may be performed contemporaneously, in parallel, or in a different order.

In FIG. 6, a process generally designated 600 includes a step 610 in which the TNEA system 184 (FIG. 1) receives the financial transaction event 140. In a step 620 the received financial transaction event 140 is parsed and processed. In a step 640 the TNEA system 184 prepares the financial transaction notification message 150. In a step 642 a determination is made whether the financial transaction data meets annotation prompting criteria including criteria based on the merchant, merchant preferences and the merchant type. If it is determined that the annotation prompting criteria are not met, then the process proceeds to a step 650 in which the financial transaction notification message 150 is served. If, on the other hand, it is determined that the annotation prompting criteria are met, then in a step 645 the TNEA system 184 determines the invitation based on the financial transaction data, and in a step 647 adds the invitation to the financial transaction notification message 150. In a step 650 the TNEA system 184 sends the financial transaction notification message 150 including the invitation to the user's mobile device 110. The steps in FIG. 6 are associated with tasks performed by the TNEA system 184.

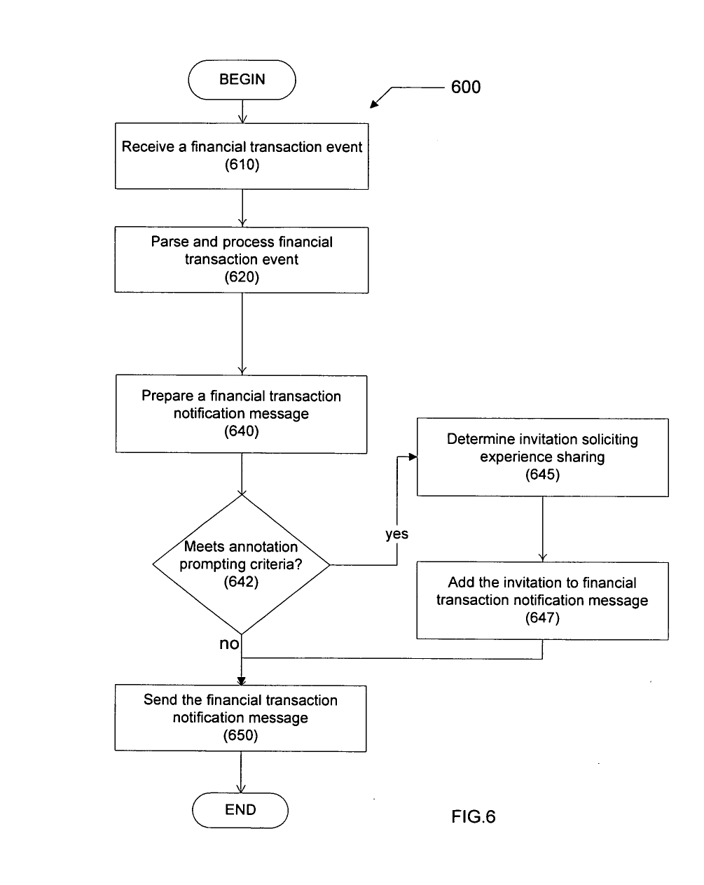

In FIG. 7, the steps are associated with end-user tasks performed on the user's mobile device 110. A process generally designated 700 includes a step 710 in which the user receives the financial transaction notification message 150. In a step 720 the user provides experience annotations associated with the product or service purchased and in a step 730 the response message, including the experience annotation, is sent to the TNEA system 184.

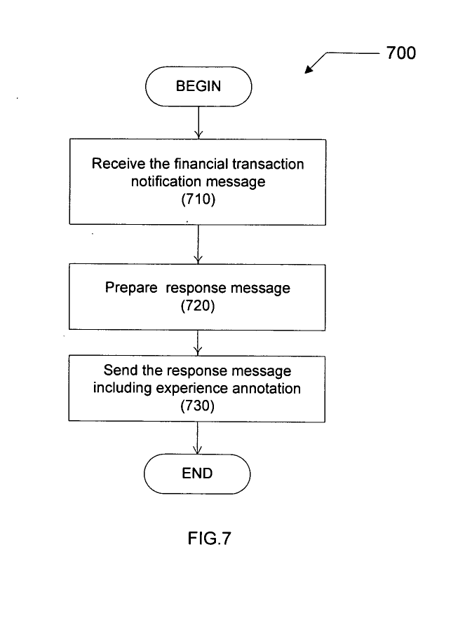

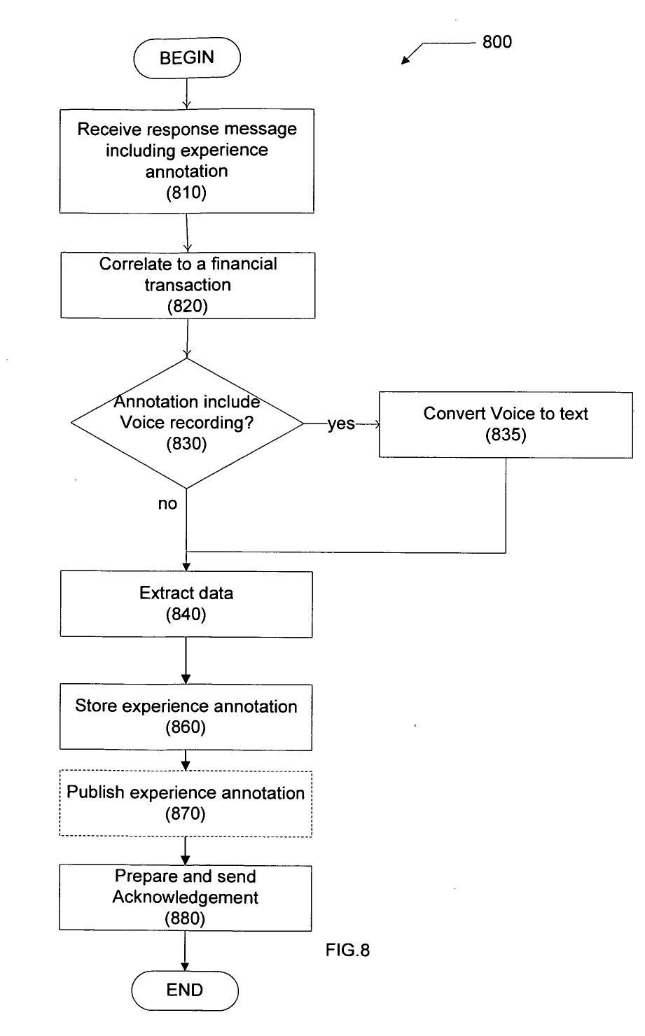

With reference to FIG. 8, the steps are associated with system tasks performed by the TNEA system 184. A process generally designated 800 includes a step 810 in which the TNEA system 184 receives the response message 160 from the user's mobile device 110. The response message 160 is correlated to the financial transaction based on an identifier found in the response message 160 in a step 820. In a step 830 a determination is made whether the response message 160 includes a voice recording If it is determined that the response message 160 includes a voice recording, then in a step 835 the voice recording is converted to text and in a step 840, heuristics are applied by the TNEA system 184 to extract data from the experience annotation. If, on the other hand, it is determined that the response message 160 does not include a voice recording, then in the step 840 the TNEA system 184 applies heuristics to extract the data from the experience annotation. In a step 860 the experience annotation is stored in the experience annotations database 440. In the following optional step 870 the experience annotation is published to one or more of the experience annotation destinations 120 in accordance with the experience annotation profile 300.

After the experience annotations are processed in steps 820-870, optionally in a step 880 an acknowledgement message 170 is prepared and sent to the user's mobile device 110.

FIGS. 9-11 illustrate sample messages exchanged in accordance with an aspect of the invention. The text shown in the sample messages is exemplary for illustrative purposes only.

FIG. 9 illustrates a sample financial transaction notification message 150. The financial transaction notification message 150 is intended to be displayed on a display 115 of a user device or terminal 110. The financial transaction notification message 150 includes financial transaction details including a merchant name 1210, a transaction amount 1230, and a transaction date and time 1240.

The financial transaction notification message 150 also includes an invitation in the form of a promotional offer 1250. The user can share experiences by replying to the message with an action code 1260.

FIG. 10 illustrates a response message 160. The response message 160 includes the selected action code 1260 and an experience annotation 1320. The experience annotation 1320 includes the user's experience and a rating 1330. The annotation analyzer module 218 is operable to extract information from the experience annotation 1320 including the rating 1330.

FIG. 11 illustrates an acknowledgement message 170 sent by the TNEA system 184 including an acknowledgement 1410. The acknowledgement message 170 also includes the promotional offer 1420.

The method and system for experience sharing using a mobile device in accordance with the invention uses a financial transaction notification message as a means for soliciting experience sharing. The financial transaction notification message is employed by the method and system to provide a new means of communication between merchants, service providers and their customers. Furthermore, the method and system enable the user to share experiences from a mobile device using voice. The method and system increase the likelihood that the user will share experiences.

In one or more exemplary configurations, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The present description of the disclosed configurations is provided to enable a person skilled in the art to make or use the invention. Various modifications to these configurations will be readily apparent to those skilled in the art, and the principles described herein may be applied to other configurations without departing from the spirit or scope of the invention. Thus, the disclosure is not intended to be limited to the configurations shown herein but is to be accorded the widest scope consistent with the principles and novel features disclosed herein.

What is claimed is:

1. A computer-implemented method for soliciting a user's experience relating to a product or service purchased from a merchant or service provider, the method comprising the steps of:
serving a financial transaction notification message to a user's mobile device, the financial transaction notification message being sent by a financial institution, the financial transaction notification message being related to a financial transaction performed by the user to purchase the product or service;
receiving a response from the mobile device including an experience annotation, the experience annotation reflecting the user's experience relating to the product or service; and
processing the experience annotation.

2. The method of claim 1, wherein serving the financial transaction notification message to the user's mobile device includes sending the financial transaction notification message to the user's mobile device using a messaging protocol including SMS, USSD, MMS, WAP Push, Email, and Web Services.

3. The method of claim 1, wherein receiving the response from the user's mobile device includes receiving the response using a messaging protocol including SMS, USSD, MMS, WAP Push, Email, and Web Services.

4. The method of claim 1, wherein receiving the response from the mobile device comprises receiving a message including any combination of text, voice, images and videos.

5. The method of claim 1, wherein receiving the response comprises receiving user input from a voice recording system.

6. The method of claim 1, wherein receiving the response comprises receiving user input from an interactive voice response system.

7. The method of claim 1, wherein serving the financial transaction notification message to the user's mobile device further comprises determining an invitation soliciting experience sharing to be included in the financial transaction notification message.

8. The method of claim 7, wherein the determination of the invitation soliciting experience sharing is based upon merchant preferences.

9. The method of claim 7, wherein the determination of the invitation soliciting experience sharing includes selecting a promotional offer.

10. The method of claim 1, wherein processing the experience annotation comprises determining a customer satisfaction level.

11. The method of claim 1, further comprising sending an acknowledgement message to the user's mobile device.

12. The method of claim 11, wherein the step of sending the acknowledgement message to the user's mobile device includes determining the acknowledgement message based on factors including the experience annotation, merchant preferences, promotional offers, and a customer satisfaction level.

13. The method of claim 1, wherein processing the experience annotation comprises publishing the experience annotation to an online site.

14. The method of claim 1, wherein processing the experience annotation comprises sending the experience annotation to the merchant or service provider.

15. The method of claim 1, wherein processing the experience annotation comprises performing voice to text conversion.

16. A system for soliciting a user's experience relating to a product or service purchased from a merchant or service provider comprising:
a transaction notification module operable to serve a financial transaction notification message to a user's mobile device, the financial transaction notification message being sent by a financial institution, the financial transaction notification message being related to a financial transaction performed by the user to purchase the product or service;
an annotation receiver module operable to receive a response from the mobile device including an experience annotation, the experience annotation reflecting the user's experience relating to the product or service; and
an annotation processor module operable to process the experience annotation.

17. The system of claim 16, wherein the transaction notification module is operable to send the financial transaction notification message using a messaging protocol including SMS, USSD, MMS, WAP Push, Email, and Web Services.

18. The system of claim 16, wherein the annotation receiver module is operable to receive the response using a messaging protocol including SMS, USSD, MMS, WAP Push, Email, and Web Services.

19. The system of claim 16, wherein the annotation receiver module is operable to receive the response as a message including any combination of text, voice, images and videos.

20. The system of claim 16, wherein the annotation receiver module is operable to receive the response as a user input from a voice recording system.

21. The system of claim 16, wherein the annotation receiver module is operable to receive the response as a user input from an interactive voice response system.

22. The system of claim 16, wherein the transaction notification module is further operable to determine an invitation soliciting experience sharing to be included in the financial transaction notification message.

23. The system of claim 22, wherein the determination of the invitation soliciting experience sharing includes selecting a promotional offer.

24. The system of claim 16, further comprising an annotation analyzer module operable to determine a customer satisfaction level from the experience annotation.

25. The system of claim 16, further comprising an acknowledgment module operable to send an acknowledgment message to the user's mobile device.

26. The system of claim 25, wherein the acknowledgment module is further operable to determine the acknowledgment message based on factors including the experience annotation, merchant preferences, promotional offers, and a customer satisfaction level.

27. The system of claim 16, further comprising one or more experience annotation handlers, each operable to publish the experience annotation to an online site.

28. The system of claim 16, further comprising a voice-to-text converter.

29. The system of claim 16, further comprising a mobile application configured on the user's mobile device operable to receive the financial transaction notification message and provide an interface for generating the response including the experience annotation.

30. The system of claim 29, wherein-the mobile application is further operable to publish the experience annotation to an online site.

31. The system of claim 16, wherein the experience annotation comprises experience sharing including feedback, reviews, surveys, ratings, blog entries, and journal entries.
